(19) United States
(12) Patent Application Publication
(10) Pub. No.: US 2026/0009286 A1
(43) Pub. Date: Jan. 8, 2026

(54) protective fence with a pet door

(71) Applicant: Zhongshan Chenbei Daily Necessities Co., Ltd., Zhongshan City (CN)

(72) Inventor: Xin Guo, Zhongshan City (CN)

(73) Assignee: Zhongshan Chenbei Daily Necessities Co., Ltd., Zhongshan City (CN)

(21) Appl. No.: 19/193,098

(22) Filed: Apr. 29, 2025

(30) Foreign Application Priority Data
Jul. 3, 2024 (CN) 202421554097.6

(51) Int. Cl. E06B 7/32; A01K 1/035; E06B 9/04

(52) U.S. Cl. CPC E06B 7/32; A01K 1/035; E06B 9/04

(57) ABSTRACT

The present invention discloses a protective fence with a pet door, comprising a door frame with a door body inside and an opening and closing locking component having a rectangular frame; the present invention provides an opening and closing locking component that allows pets to easily pass through the protective fence through the door panel. This component has a stopper A and a stopper B, and the coordinated use of the two stoppers effectively control whether pets can freely leave after entering and exiting the door panel. In order to further optimize the use experience, users can paste mute hairs in the adhesive groove on the door panel. When pets come in and out, the mute hairs in the adhesive groove can significantly reduce the sound generated, avoiding potential noise problems.

### REFERENCE TO PRIOR APPLICATION

This application claims priority to Chinese Patent Application 202421554097.6, filed on Jul. 3, 2024, which is incorporated herein by reference.

### TECHNICAL FIELD

The present invention relates to the field of protective fence technology, particularly to a protective fence with a pet door.

### BACKGROUND

Nowadays, many families have pets. In order to restrict the activity range of pets at home, especially in narrow passages or door openings, people will install pet guardrails that can effectively prevent pets from walking around freely when users are out. However, the current design of pet guardrails faces inconveniences: when users go home and want their pets to move freely, they need to open the protective fence door which, due to its large volume, will take up space when opened and is also inconvenient to operate. It is therefore particularly important to improve the design of pet guardrails.

### SUMMARY

The design of the existing pet fence mentioned above faces the following inconveniences: when users go home and want their pets to move freely, they need to open the protective fence door which, due to its large volume, will take up space when opened and is also inconvenient to operate.

In order to address the above problem, the present invention discloses a protective fence with a pet door, comprising:
a door frame with a door body inside; and
an opening and closing locking component on the lower side of the door body, wherein the opening and closing locking component has a rectangular frame on the lower side of the door body, the outer side of the rectangular frame is fitted with a shell A, and the side surface of the shell A is connected to a shell B, a caulking groove is provided between shell A and shell B, and a bearing is embedded in the groove and is fixedly fitted with a door panel.

As a further technical solution, the door frame has reserved holes at the upper and lower ends on opposite sides.

As a further technical solution, the lower end pin of shell A is connected to stopper A.

As a further technical solution, the lower end pin of shell B is connected to stopper B.

As a further technical solution, the door panel is provided with an adhesive groove on the outer surface.

Compared with the existing technology, the present invention has the following advantages and positive effects:

The opening and closing locking component allows pets to easily pass through the protective fence through the door panel. This component has a stopper A and a stopper B, and the coordinated use of the two stoppers effectively control whether pets can freely leave after entering and exiting the door panel. In order to further optimize the use experience, users can paste mute hairs in the adhesive groove on the door panel. When pets come in and out, the mute hairs in the adhesive groove can significantly reduce the sound generated, avoiding potential noise problems.

### BRIEF DESCRIPTION OF DRAWINGS

In order to more clearly illustrate the technical solution of the embodiments of the present invention, a brief introduction will be given to the accompanying drawings required for the description of the embodiments. Obviously, the accompanying drawings described below are some embodiments of the present invention. those of ordinary skill in the art can obtain other drawings based on these drawings without creative work.

FIG. 1 is a perspective view of a protective fence with a pet door provided in the embodiment;

FIG. 2 is an exploded view of a protective fence with a pet door provided in the embodiment;

FIG. 3 is an exploded view from another perspective of a protective fence with a pet door provided in the embodiment;

FIG. 4 is a partial enlarged view of a protective fence with a pet door provided in the embodiment;

Where: 1. Door frame; 2. Door body; 3. Opening and closing locking components; 3-1. Rectangular frame; 3-2. Shell A; 3-3. Shell B; 3-4. Caulking groove; 3-5. Bearing; 3-6. Door panel; 3-7, Stopper A; 3-8, Stopper B; 3-9, Adhesive groove; 4. Reserved hole.

### DETAILED DESCRIPTION OF EMBODIMENTS

In order to better understand the above objectives, features, and advantages of the present invention, the present invention will be further illustrated below in conjunction with the accompanying drawings and embodiments. It should be noted that, without conflict, the embodiments and features of the present application can be combined with each other. Many specific details are elaborated in the following description to facilitate a full understanding of the present invention. However, the present invention can also be implemented in other ways different from those described herein. Therefore, the present invention is not limited to the specific embodiments disclosed in the following specification.

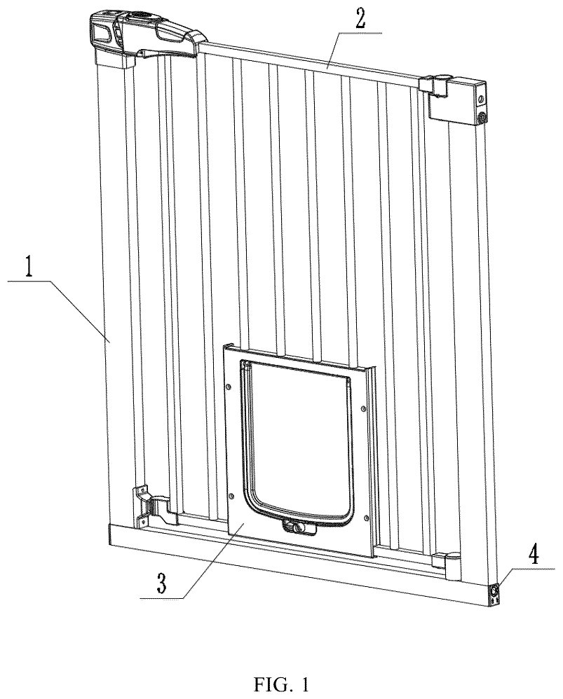

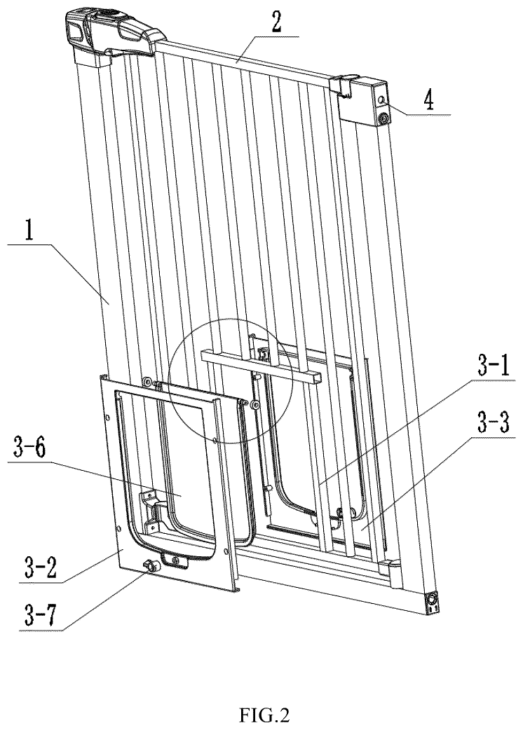

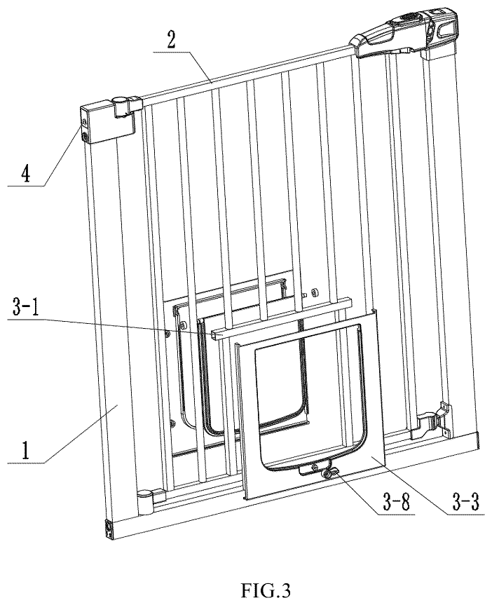

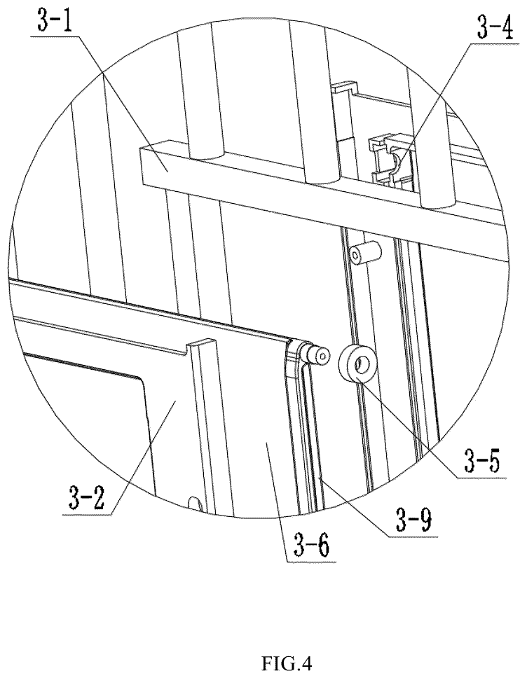

In the embodiment, as shown in FIG. 1-4 o the specification, the solution provides a protective fence with a pet door, comprising:
a door frame 1 with a door body 2 inside; and
an opening and closing locking component 3 on the lower side of the door body 2, wherein the opening and closing locking component 3 has a rectangular frame 3-1 on the lower side of the door body 2, the outer side of the rectangular frame 3-1 is fitted with a shell A 3-2, and the side surface of the shell A 3-2 is connected to a shell B 3-3, a caulking groove 3-4 is provided between shell A 3-2 and shell B 3-3, and a bearing 3-5 is embedded in the groove and is fixedly fitted with a door panel 3-6.

As shown in FIG. 1-4 of the specification, the door frame 1 has reserved holes 4 at the upper and lower ends on opposite sides; the lower end pin of shell A 3-2 is connected to stopper A 3-7; the lower end pin of shell B 3-3 is connected to stopper B 3-8; the door panel 3-6 is provided with an adhesive groove 3-9 on the outer surface.

It should be emphasized that in the specific implementation process, firstly, the door frame 1 is accurately fixed in the required position and, during the fixing process, the jackscrew in the reserved hole 4 is screwed against the surface of the wall or door opening, thereby firmly fixing the door frame 1 and, in order to ensure the safety of the pet, the owner, when leaving home, can screw the stopper A3-7 on the shell A3-2 and the stopper B3-8 on the shell B3-3 to a position perpendicular to the ground, so that the stopper A3-7 and the stopper B3-8 will jointly block the door panel 3-6 to prevent the pet from passing through the protective fence at will;

in order to facilitate free access for the pet, the owner, when returning home, can screw the stoppers A3-7 and B3-8 to a position parallel to the ground, allowing the pet to pass through the protective fence. The pet needs to lift the door panel 3-6 with head, and the door panel 3-6 can be easily flipped up and down through the bearing 3-5 embedded in the caulking groove 3-4, such that the pet can pass through the protective fence through the rectangular groove on the door panel 3-6, and when there is no external force, the door panel 3-6 fits with the bearing 3-5 through its own weight, always maintaining a vertical position with the ground;

In some cases, if the owner hope that the pet can pass through the protective fence in one direction, such as only allowing pets to enter or to leave, the owner can individually screw the stopper A3-7 or B3-8 to a position perpendicular to the ground, such that the pet can pass through the protective fence in the set direction, performing the function of only allowing entry but exit or only allowing exit but entry;

In order to further enhance the user experience and reduce the sound generated by pets flipping the door panel 3-6, mute hairs can also be adhered in the adhesive groove 3-9 to effectively reduce the noise generated when the door panel flips 3-6, ensuring that pets will not disturb owner families when passing through the protective fence.

Only a preferred embodiments of the present invention are described above, and it is not intended to limit the present invention in any other form. Any person skilled in the art may use the disclosed technical content to modify or adapt equivalent embodiments to other fields. However, any simple modifications, equivalent changes, and adaptations made to the above embodiments based on the technical essence of the present invention without departing from the technical solution of the present invention still fall within the protection scope of the technical solution of the present invention.

What is claimed is:

1. A protective fence with a pet door, comprising:
a door frame (1) with a door body (2) inside; and
an opening and closing locking component (3) on the lower side of the door body (2), wherein the opening and closing locking component (3) has a rectangular frame (3-1) on the lower side of the door body (2), the outer side of the rectangular frame (3-1) is fitted with a shell A (3-2), and the side surface of the shell A (3-2) is connected to a shell B (3-3), a caulking groove (3-4) is provided between shell A (3-2) and shell B (3-3), and a bearing (3-5) is embedded in the groove and is fixedly fitted with a door panel (3-6).

2. A protective fence with a pet door according to claim 1, wherein the door frame (1) has reserved holes (4) at the upper and lower ends on opposite sides.

3. A protective fence with a pet door according to claim 1, wherein the lower end pin of shell A (3-2) is connected to stopper A (3-7).

4. A protective fence with a pet door according to claim 1, wherein the lower end pin of shell B (3-3) is connected to stopper B (3-8).

5. A protective fence with a pet door according to claim 1, wherein the door panel (3-6) is provided with an adhesive groove (3-9) on the outer surface.
